(19) United States
(12) Patent Application Publication
(10) Pub. No.: US 2015/0220326 A1
(43) Pub. Date: Aug. 6, 2015

(54) Mobile Terminal and Software Upgrade Method Thereof

(71) Applicant: Huawei Device Co., Ltd., Shenzhen (CN)

(72) Inventor: Zhifeng Jia, Beijing (CN)

(21) Appl. No.: 14/687,502

(22) Filed: Apr. 15, 2015

Related U.S. Application Data
(63) Continuation of application No. PCT/CN2013/084526, filed on Sep. 27, 2013.

(30) Foreign Application Priority Data
Oct. 15, 2012 (CN) 201210389967.4

(51) Int. Cl. G06F 9/44

(52) U.S. Cl. CPC G06F 8/68; G06F 8/71

(57) ABSTRACT

A mobile terminal and a software upgrade method thereof are provided. The method includes acquiring a differential upgrade package for software of an original version; and using the software of the original version as software of a reference version, differentially upgrading, by using the differential upgrade package, the software of the reference version to software of an upgrade version subsequently used by a mobile terminal, and retaining the software of the original version at the same time. According to the foregoing disclosed content, in technical solutions disclosed in the embodiments of the present invention, the software of the original version can be retained to ensure that the software of the reference version is unchanged, thereby effectively resolving a problem that the software of the original version cannot be retained and a reference version subsequently upgraded is disorderly controlled.

### CROSS-REFERENCE TO RELATED APPLICATIONS

This application is a continuation of International Application No. PCT/CN2013/084526, filed on Sep. 27, 2013, which claims priority to Chinese Patent Application No. 201210389967.4, filed on Oct. 15, 2012, both of which are hereby incorporated by reference in their entireties.

### TECHNICAL FIELD

The present invention relates to the field of communications technologies, and in particular, to a mobile terminal and a software upgrade method thereof.

### BACKGROUND

There is an increasingly intense need for version upgrades of a mobile terminal, such as a mobile phone, a tablet computer, a netbook, and a Personal Digital Assistant (PDA). Operators require mobile terminal manufacturers to provide a high-efficient, timely, and accurate version upgrade.

In the prior art, a mobile terminal can acquire, by using a Firmware Over The Air (FOTA) technology, upgrade packages released by software suppliers for various operating systems, for example, an AndroidPackage (APK) upgrade package for an Android® operating system, an upgrade package for a Symbian® operating system, or an upgrade package for an iPhone® Operating System (iOS).

An example that a mobile phone using an Android® operating system is upgraded by using an APK upgrade package is used in the following to describe an FOTA software upgrade method of a mobile terminal in the prior art.

In the prior art, a mobile phone manufacturer uses a differential file of a latest version such as apk1.1 and an original version such as apk1.0, as an upgrade package, and places the upgrade package in an upgrade server; and a mobile phone downloads, by using an FOTA upgrade, the upgrade package from the server to a cache partition of the mobile phone, and then a differential upgrade program upgrades, by using the upgrade package, the apk1.0 in a system partition to the latest version apk1.1 in a manner of adding, deleting, modifying a file, or the like.

In the prior art, software of a reference version upgraded from the version apk1.0 to the version apk1.1 is the version apk1.0, software of a reference version upgraded from the version apk1.1 to a version apk1.2 is the version apk1.1, software of a reference version upgraded from the version apk1.2 to a version apk1.3 is the version apk1.2 . . . , and therefore, software of a reference version continuously changes, which has the following disadvantages.

The apk1.0 version used as software of the original version cannot be retained. The upgrade package apk1.1 is downloaded to a cache partition and an upgrade is performed in the system partition, the original software apk1.0 of the reference version is changed to the apk1.1, and the original version apk1.0 is completely overridden by the version apk1.1 and cannot be retained.

A reference version subsequently upgraded is disorderly controlled. The mobile phone downloads the upgrade package apk1.1 to the cache partition and copies the upgrade package apk1.1 to the system partition, and the original reference version apk1.0 is changed to apk1.1. Therefore, an upgrade package subsequently released by the server needs to be prepared according to the apk1.1, and in this way, there are increasing reference versions that are inconvenient for management.

### SUMMARY

A main technical problem to be resolved in the present invention is to provide a mobile terminal and a software upgrade method thereof, which can ensure that software of a reference version is unchanged, thereby effectively resolving a problem that software of an original version cannot be retained and a reference version subsequently upgraded is disorderly controlled.

A first aspect provides a software upgrade method of a mobile terminal, where the method includes the following steps: acquiring a differential upgrade package for software of an original version; and using the software of the original version as software of a reference version, differentially upgrading, by using the differential upgrade package, the software of the reference version to software of an upgrade version, and retaining the software of the original version at the same time.

With reference to an implementation manner of the first aspect, in a first possible implementation manner, the step of using the software of the original version as software of a reference version, differentially upgrading, by using the differential upgrade package, the software of the reference version to software of an upgrade version, and retaining the software of the original version at the same time includes copying the software of the original version from a system partition to a user data partition; and using the software of the original version in the user data partition as the software of the reference version, differentially upgrading, by using the differential upgrade package, the software of the reference version to the software of the upgrade version, and enabling the software of the upgrade version in the user data partition.

With reference to the implementation manner of the first aspect, in a second possible implementation manner, the step of using the software of the original version as software of a reference version, differentially upgrading, by using the differential upgrade package, the software of the reference version to software of an upgrade version, and retaining the software of the original version at the same time includes copying the software of the original version from a system partition to a user data partition; and using the software of the original version in the system partition as the software of the reference version, differentially upgrading, by using the differential upgrade package, the software of the reference version to the software of the upgrade version, and enabling the software of the upgrade version in the system partition.

With reference to either of the first and the second possible implementation manners of the first aspect, in a third possible implementation manner, the method further includes acquiring a factory defaults restoration request; and deleting the software of the upgrade version according to the factory defaults restoration request, and enabling the software of the original version.

With reference to the third possible implementation manner of the first aspect, in a fourth possible implementation manner, the step of deleting the software of the upgrade version according to the factory defaults restoration request, and enabling the software of the original version includes formatting the user data partition according to the factory defaults restoration request, and enabling the software of the original version in the system partition.

With reference to the fourth possible implementation manner of the first aspect, in a fifth possible implementation manner, the step of deleting the software of the upgrade version according to the factory defaults restoration request, and enabling the software of the original version includes performing, according to the factory defaults restoration request, an exchange between the software of the upgrade version in the system partition and the software of the original version in the user data partition; and formatting the user data partition, and enabling the software of the original version in the system partition.

With reference to any one of the first to the fifth possible implementation manners of the first aspect, in a sixth possible implementation manner, the step of acquiring a differential upgrade package for software of an original version includes downloading, from a server to a cache partition, the differential upgrade package for the software of the original version.

A second aspect provides a mobile terminal, including an upgrade package acquiring unit configured to acquire a differential upgrade package for software of an original version; and a differential upgrade unit configured to use the software of the original version as software of a reference version, differentially upgrade, by using the differential upgrade package, the software of the reference version to software of an upgrade version subsequently used by the mobile terminal, and retain the software of the original version at the same time.

With reference to an implementation manner of the second aspect, in a first possible implementation manner, the differential upgrade unit is configured to copy the software of the original version from a system partition to a user data partition; and use the software of the original version as the software of the reference version, differentially upgrade, by using the differential upgrade package, the software of the original version in the user data partition to the software of the upgrade version, and enable the software of the upgrade version in the user data partition.

With reference to the implementation manner of the second aspect, in a second possible implementation manner, the differential upgrade unit is configured to copy the software of the original version from a system partition to a user data partition; and use the software of the original version as the software of the reference version, differentially upgrade, by using the differential upgrade package, the software of the original version in the system partition to the software of the upgrade version, and enable the software of the upgrade version in the system partition.

With reference to either of the first and the second possible implementation manners of the second aspect, in a third possible implementation manner, the mobile terminal further includes a restoring module, where the restoring module is configured to acquire a factory defaults restoration request; and delete the software of the upgrade version according to the factory defaults restoration request, and enable the software of the original version.

With reference to the third possible implementation manner of the second aspect, in a fourth possible implementation manner, the restoring module is configured to format the user data partition according to the factory defaults restoration request, and enable the software of the original version in the system partition.

With reference to the fourth possible implementation manner of the second aspect, in a fifth possible implementation manner, the restoring module is configured to perform, according to the factory defaults restoration request, an exchange between the software of the upgrade version in the system partition and the software of the original version in the user data partition; and format the user data partition, and enable the software of the original version in the system partition.

With reference to any one of the first to the fifth possible implementation manners of the second aspect, in a sixth possible implementation manner, the upgrade package acquiring unit is configured to download, from a server to a cache partition, the differential upgrade package for the software of the original version.

Different from a condition of the prior art, according to the mobile terminal and the software upgrade method thereof in the embodiments of the present invention, software of an original version is used as software of a reference version, the software of the reference version is differentially upgraded, by using a differential upgrade package, to software of an upgrade version subsequently used by the mobile terminal, and the software of the original version is retained at the same time, which ensures that the software of the reference version is unchanged, thereby effectively resolving a problem that the software of the original version cannot be retained and a reference version subsequently upgraded is controlled disorderly.

### BRIEF DESCRIPTION OF THE DRAWINGS

To describe the technical solutions of the embodiments of the present invention more clearly, the following briefly introduces the accompanying drawings required for describing the embodiments. The accompanying drawings in the following description show some embodiments of the present invention, and a person of ordinary skill in the art may still derive other drawings from these accompanying drawings without creative efforts.

FIG. 1 is a flowchart of a software upgrade method of a mobile terminal according to a first embodiment of the present invention;

FIG. 2 is a schematic system structure diagram of a mobile terminal according to the first embodiment of the present invention;

FIG. 3 is a schematic system structure diagram of a mobile terminal according to a second embodiment of the present invention;

FIG. 4 is a flowchart of a software upgrade method of the mobile terminal according to the second embodiment of the present invention;

FIG. 5 is a flowchart of a software upgrade method of a mobile terminal according to a third embodiment of the present invention;

FIG. 6 is a flowchart of a software upgrade method of a mobile terminal according to a fourth embodiment of the present invention;

FIG. 7 is a flowchart of a software upgrade method of a mobile terminal according to a fifth embodiment of the present invention; and

FIG. 8 is a schematic structural diagram of hardware of a mobile terminal according to a sixth embodiment of the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. The described embodiments are some but not all of the embodiments of the present invention. All other embodiments obtained by a person of ordinary skill in the art based on the embodiments of the present invention without creative efforts shall fall within the protection scope of the present invention.

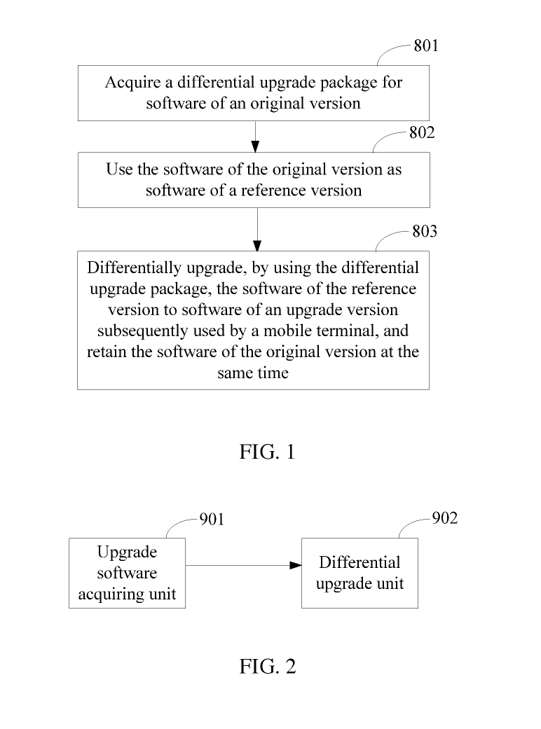

First, referring to FIG. 1, FIG. 1 is a flowchart of a software upgrade method of a mobile terminal according to a first embodiment of the present invention. As shown in FIG. 1, the first embodiment of the present invention provides the software upgrade method of a mobile terminal, where the method includes the following steps.

Step 801: Acquire a differential upgrade package for software of an original version.

Step 802: Use the software of the original version as software of a reference version.

Step 803: Differentially upgrade, by using the differential upgrade package, the software of the reference version to software of an upgrade version, and retain the software of the original version at the same time.

Referring to FIG. 2, FIG. 2 is a schematic system structure diagram of a mobile terminal according to the first embodiment of the present invention. As shown in FIG. 2, the first embodiment of the present invention further provides a mobile terminal, where the mobile terminal includes an upgrade software acquiring unit 901 configured to acquire a differential upgrade package for software of an original version; and a differential upgrade unit 902 configured to use the software of the original version as software of a reference version, differentially upgrade, by using the differential upgrade package, the software of the reference version to software of an upgrade version, and retain the software of the original version at the same time.

According to the foregoing technical solutions, according to the mobile terminal and the software upgrade method thereof in this embodiment of the present invention, software of an original version is used as software of a reference version, the software of the reference version is differentially upgraded, by using a differential upgrade package, to software of an upgrade version subsequently used by a mobile terminal, and the software of the original version is retained at the same time, which ensures that the software of the reference version is unchanged, thereby effectively resolving a problem that the software of the original version cannot be retained and a reference version subsequently upgraded is controlled disorderly.

The mobile terminal and the software upgrade method thereof according to this embodiment of the present invention are described in detail in the following with reference to a specific embodiment.

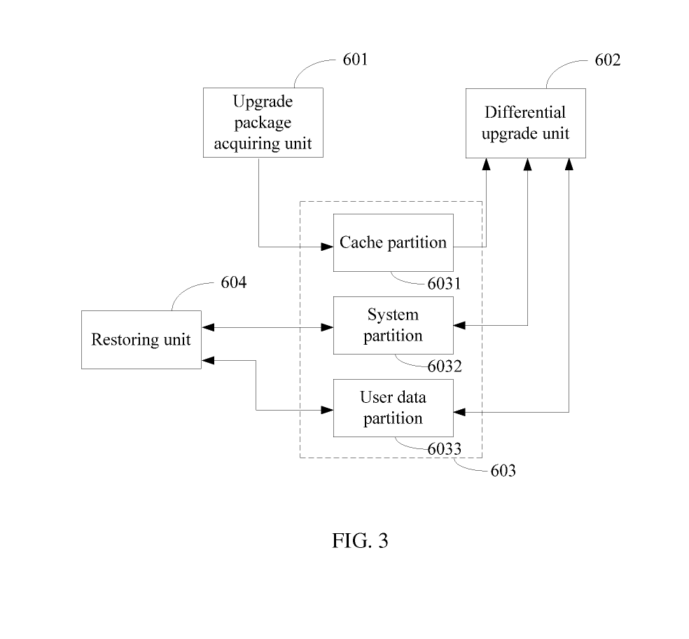

First, referring to FIG. 3, FIG. 3 is a schematic system structure diagram of a mobile terminal according to a second embodiment of the present invention. As shown in FIG. 3, in the second embodiment of the present invention, the mobile terminal includes an upgrade package acquiring unit 601, a differential upgrade unit 602, a restoring unit 604, and a file system 603, where the file system 603 includes a cache partition 6031, a system partition 6032, and a user data partition 6033. Functions of the above upgrade package acquiring unit 601, differential upgrade unit 602, and restoring unit 604 are introduced in the following. The file system 603 is a storage partition allocated by an operating system, is a common technology in the art, and is not described herein again.

In addition, in an alternative embodiment of the present invention, the restoring unit 604 may be selected according to actual requirements. In an embodiment without a need to restore system factory defaults (described in detail in the following), setting of the restoring unit 604 can be omitted, and after the setting of the restoring unit 604 is omitted, the present invention can still effectively resolve a problem that software of an original version cannot be retained and a reference version subsequently upgraded is disorderly controlled.

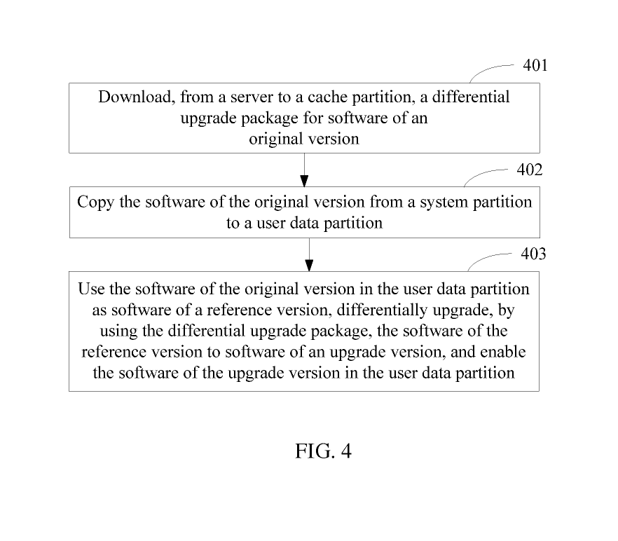

In addition, referring to FIG. 4, FIG. 4 is a flowchart of a software upgrade method of the mobile terminal according to the second embodiment of the present invention. As shown in FIG. 4, in this embodiment, the software upgrade method of the mobile terminal in the present invention includes the following steps.

Step 401: Download, from a server to the cache partition 6031, a differential upgrade package for software of an original version.

An Android® operating system is used as an example. The software of the original version is apk1.0, and the mobile terminal downloads a differential upgrade package pack1 (such as a lib or a so file) for the apk1.0 to the cache partition 6031, where the differential upgrade package pack1 is a file obtained by performing differential processing between software apk1.1 of an upgrade version and the software apk1.0 of the original version.

Step 402: Copy the software of the original version from the system partition 6032 to the user data partition 6033.

According to the above example, that is, the apk1.0 is copied from the system partition 6032 to the user data partition 6033.

Step 403: Use the software of the original version in the user data partition 6033 as software of a reference version, differentially upgrade, by using the differential upgrade package, the software of the reference version, so as to acquire software of an upgrade version, and enable the software of the upgrade version in the user data partition 6033.

According to the above example, that is, the software apk1.0 of the original version in the user data partition 6033 is used as software apk1.0 of a reference version, the software apk1.0 of the reference version is differentially upgraded, by using the differential upgrade package pack1, so as to acquire the software apk1.1 of the upgrade version, and the software apk1.1 of the upgrade version in the user data partition 6033 is enabled.

It should be noted that, when a new version is released, the foregoing step 401 to step 403 are repeated, so as to acquire updated software of an upgrade version from the user data partition 6033, so that the mobile terminal can use the updated software of the upgrade version.

An Android® operating system is still used as an example for description in the following. If updated software apk1.2 of an upgrade version is released, in the foregoing step 401, a differential upgrade package pack2 for the software apk1.0 of the original version can be downloaded, where the differential upgrade package pack2 is a file obtained by performing differential processing between the updated software apk1.2 of the upgrade version and the software apk1.0 of the original version.

In step 402, the apk1.0 is copied from the system partition 6032 to the user data partition 6033.

In step 403, the software apk1.0 of the original version in the user data partition 6033 is used as the software apk1.0 of the reference version, the software apk1.0 of the reference version is differentially upgraded, by using the differential upgrade package pack2, so as to acquire the software apk1.2 of the upgrade version, and the software apk1.2 of the upgrade version in the user data partition 6033 is enabled.

The foregoing step 401 is performed by the upgrade package acquiring unit 601, and steps 402 and 403 are performed by the differential upgrade unit 602.

In the second embodiment of the present invention, software of an original version is retained in a system partition 6032; when a differential upgrade is being performed, the software of the original version is copied to a user data partition 6033, and software of an upgrade version is applied in the user data partition 6033; therefore, the software of the original version can be used as software of a reference version for performing a differential upgrade in a subsequent upgrade, so as to enable that the software of the reference version is unchanged, thereby effectively resolving a problem that the software of the original version cannot be retained and a reference version subsequently upgraded is disorderly controlled. In addition, in some differential upgrades, a capacity of the system partition 6032 is required to be limited, and therefore, both an insufficient remaining capacity of the system partition 6032 and a capacity difference between the system partition 6032 before and after an upgrade may result in an upgrade failure. However, in this embodiment, a differential upgrade is performed in the user data partition 6033, and data in the system partition 6032 is unchanged, thereby effectively avoiding this problem.

However, in this embodiment, software, such as apk1.1 and apk1.2, of an upgrade version, is continuously produced in the user data partition 6033 in step 403, and therefore, a capacity of the user data partition 6033 continuously becomes larger; in addition, in an actual use, a user also has a requirement of factory defaults restoration, and therefore, in a third embodiment of the present invention, a function of factory defaults restoration is set based on the second embodiment, so that when a factory defaults restoration request is received, old software of an upgrade version is deleted in the user data partition 6033, so as to implement factory defaults restoration.

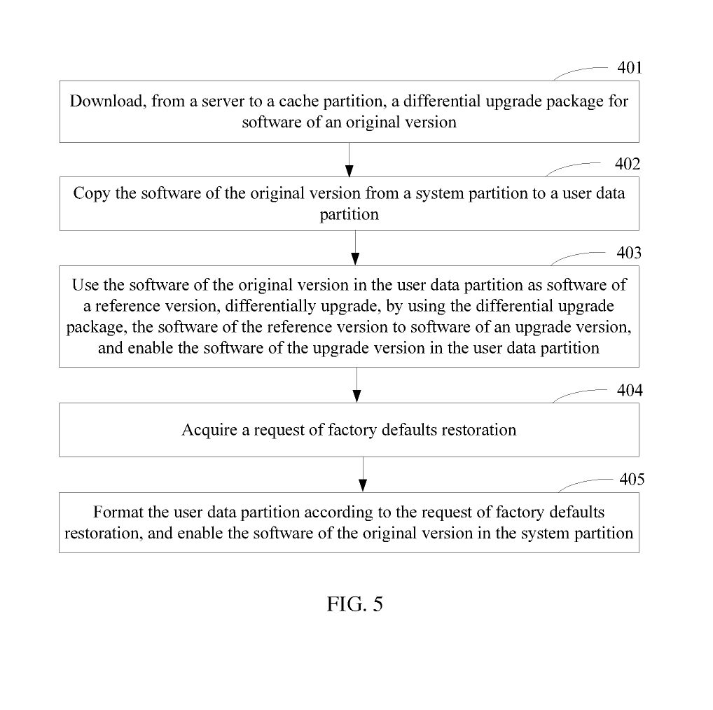

Referring to FIG. 5, FIG. 5 is a flowchart of a software upgrade method of a mobile terminal according to the third embodiment of the present invention. As shown in FIG. 5, in the software upgrade method of the mobile terminal in this embodiment, the following steps are added based on the second embodiment.

Step 404: Acquire a factory defaults restoration request.

A factory defaults restoration request that is input by a user may be acquired through a corresponding input interface that is set in an interaction interface of the mobile terminal. A selection menu may be provided, and when the user selects, by using an input device such as a keyboard and a touchscreen, an interface option with a prompt of “factory defaults restoration”, a factory defaults restoration request is generated. The mobile terminal acquires the factory defaults restoration request, so as to perform a subsequent operation.

Step 405: Format the user data partition 6033 according to the factory defaults restoration request, and enable the software of the original version in the system partition 6032.

The foregoing step 404 and step 405 are performed by the restoring unit 604 shown in FIG. 3.

An Android® operating system is used as an example. The user data partition 6033 is formatted according to the factory defaults restoration request, so that the software apk1.1 of the upgrade version is deleted; and the software apk1.0 of the original version in the system partition 6032 is enabled.

Therefore, in the third embodiment of the present invention, steps 404 and 405 are added based on the second embodiment, and therefore the software of the upgrade version in the user data partition 6033 can be effectively deleted, so that after performing factory defaults restoration, the mobile terminal can re-enable the software of the original version.

The foregoing upgrade software acquiring unit 601 is configured to perform step 401, the differential upgrade unit 602 is configured to perform steps 402-403, and the restoring unit 603 is configured to perform steps 404-405.

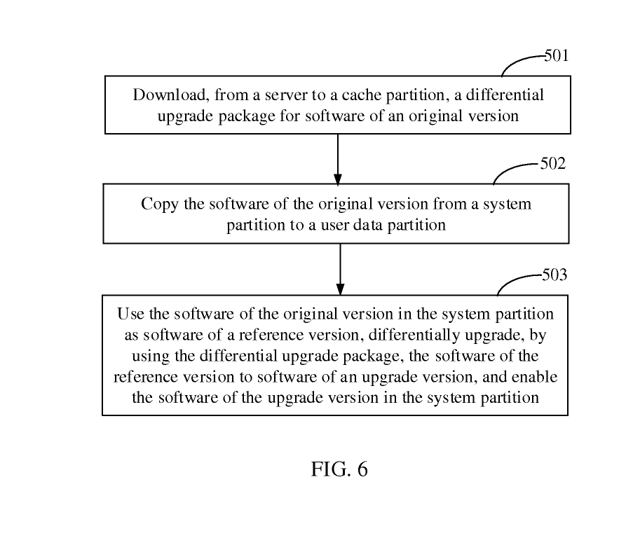

Referring to FIG. 6, FIG. 6 is a flowchart of a software upgrade method of a mobile terminal according to a fourth embodiment of the present invention. The method shown in FIG. 6 is also applicable to the mobile terminal shown in FIG. 3. As shown in FIG. 6, in this embodiment, the software upgrade method of the mobile terminal includes the following steps.

Step 501: Download, from a server to a cache partition 6031, a differential upgrade package for software of an original version.

An Android® operating system is used as an example. The software of the original version is apk1.0, and the mobile terminal downloads a differential upgrade package pack1 (such as a lib or a so file) for the apk1.0 to the cache partition 6031, where the differential upgrade package pack1 is a file obtained by performing differential processing between software apk1.1 of an upgrade version and the software apk1.0 of the original version.

Step 502: Copy the software of the original version from a system partition 6032 to a user data partition 6033.

According to the above example, that is, the apk1.0 is copied from the system partition 6032 to the user data partition 6033.

Step 503: Use the software of the original version in the system partition 6032 as software of a reference version, differentially upgrade, by using the differential upgrade package, the software of the reference version to software of an upgrade version, and enable the software of the upgrade version in the system partition 6032.

According to the above example, that is, the software apk1.0 of the original version in the system partition 6032 is used as software apk1.0 of a reference version, the software apk1.0 of the reference version is differentially upgraded by using the differential upgrade package pack1, so as to acquire the software apk1.1 of the upgrade version, and the software apk1.1 of the upgrade version in the system partition 6032 is enabled.

It should be noted that, when a new version is released, the foregoing step 501 to step 503 are repeated, so as to acquire updated software of an upgrade version from the system partition 6032, so that the mobile terminal can use the updated software of the upgrade version.

An Android® operating system is still used as an example for description in the following. If updated software apk1.2 of an upgrade version is released, in the foregoing step 401, a differential upgrade package pack2 for the software apk1.0 of the original version can be downloaded, where the differential upgrade package pack2 is a file obtained by performing differential processing between the updated software apk1.2 of the upgrade version and the software apk1.0 of the original version.

In step 502, the apk1.0 is copied from the system partition 6032 to the user data partition 6033.

In step 503, the software apk1.0 of the original version in the system partition 6032 is used as the software apk1.0 of the reference version, the software apk1.0 of the reference version is differentially upgraded by using the differential upgrade package pack2, so as to acquire the software apk1.2 of the upgrade version, and the software apk1.2 of the upgrade version in the user data partition 6033 is enabled.

In the fourth embodiment of the present invention, software of an original version is retained in a user data partition 6033; when a differential upgrade is performed, the software of the original version is copied to the user data partition 6033, and software of an upgrade version is applied in a system partition 6032; therefore, the software of the original version can be used as software of a reference version for performing a differential upgrade in a subsequent upgrade, which ensures that the software of the reference version is unchanged, thereby effectively resolving a problem that the software of the original version cannot be retained and a reference version subsequently upgraded is disorderly controlled.

However, in this embodiment, software, such as apk1.1 and apk1.2, of an upgrade version, is continuously produced in the system partition 6032 in step 503, and therefore, a capacity of the system partition 6032 continuously becomes larger; in addition, in an actual use, a user also has a requirement of factory defaults restoration, and therefore, in a fifth embodiment of the present invention, a function of factory defaults restoration is set based on the fourth embodiment, so as to delete old software of an upgrade version, and implement the function of factory defaults restoration.

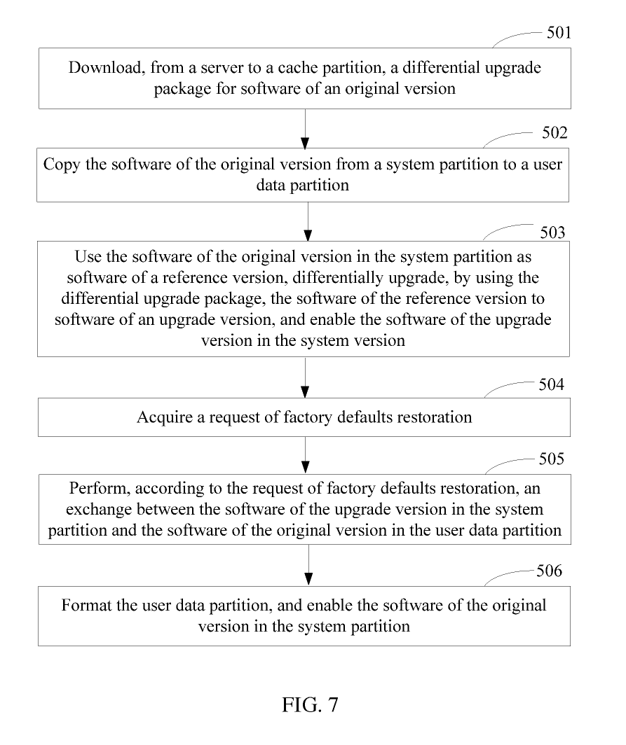

Referring to FIG. 7, FIG. 7 is a flowchart of a software upgrade method of a mobile terminal according to the fifth embodiment of the present invention. As shown in FIG. 7, in the software upgrade method of the mobile terminal in this embodiment, the following steps are added based on the fourth embodiment.

Step 504: Acquire a factory defaults restoration request.

A factory defaults restoration request that is input by a user may be acquired through a corresponding input interface that is set in an interaction interface of the mobile terminal. A selection menu may be provided, and when the user selects, by using an input device such as a keyboard and a touchscreen, an interface option with a prompt of “factory defaults restoration”, a factory defaults restoration request is generated. The mobile terminal acquires the factory defaults restoration request, so as to perform a subsequent operation.

Step 505: Perform, according to the factory defaults restoration request, an exchange between the software of the upgrade version in the system partition 6032 and the software of the original version in the user data partition 6033.

An Android® operating system is used as an example. An exchange between the software apk1.1 of the upgrade version in the system partition 6032 and the software apk1.0 of the original version in the user data partition 6033 is performed according to the factory defaults restoration request, so that the software apk1.1 of the upgrade version is in the user data partition 6033 and the software apk1.0 of the original version is in the system partition 6032 (before the exchange is performed, the software apk1.1 of the upgrade version is in the system partition 6032, and the software apk1.0 of the original version is in the user data partition 6033).

Step 506: Format the user data partition 6033, and enable the software of the original version in the system partition 6032.

An Android® operating system is used as an example, the software apk1.1 of the upgrade version is deleted by formatting the user data partition 6033, and the mobile terminal re-enables the software apk1.0 of the original version in the system partition 6032, so as to implement factory defaults restoration.

Therefore, in the fifth embodiment of the present invention, steps 505 to 507 are added based on the fourth embodiment, and therefore, software of an upgrade version in the system partition 6032 can be effectively deleted, so that after performing factory defaults restoration, the mobile terminal can re-enable the software of the original version.

The foregoing upgrade software acquiring unit 601 is configured to perform step 501, the differential upgrade unit 602 is configured to perform steps 502-503, and the restoring unit 603 is configured to perform steps 504-506.

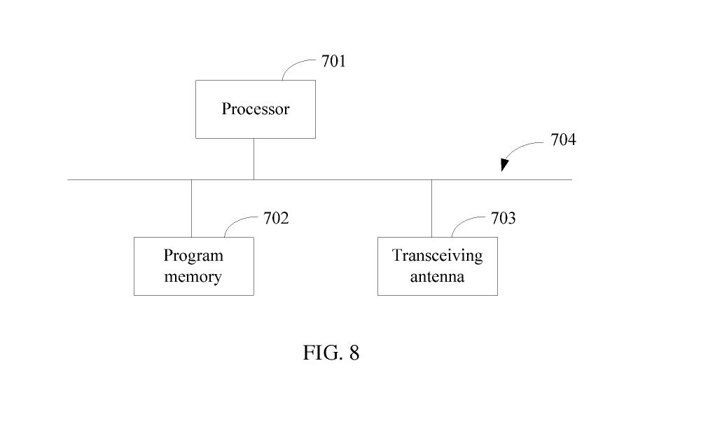

Referring to FIG. 8, FIG. 8 is a schematic structural diagram of hardware of a mobile terminal according to a sixth embodiment of the present invention. As shown in FIG. 8, the mobile terminal of the present invention includes the following hardware modules: a transceiving antenna 703; a processor 701, which is coupled to the transceiving antenna 703; and a program memory 702, which is coupled to the processor 701 and stores a first instruction that is used to control the transceiving antenna 703 to acquire a differential upgrade package for software of an original version; and a second instruction that is used to use the software of the original version as software of a reference version, differentially upgrade, by using the differential upgrade package, the software of the reference version to software of an upgrade version subsequently used by the mobile terminal, and retain the software of the original version at the same time. The processor 701 runs the first instruction and the second instruction in sequence.

It should be noted that, the transceiving antenna 703 and the program memory 702 are coupled to the processor 701 by using a bus 704.

The second instruction is used to copy the software of the original version from a system partition to a user data partition; and use the software of the original version as the software of the reference version, differentially upgrade, by using the differential upgrade package, the software of the original version in the user data partition to the software of the upgrade version, and enable the software of the upgrade version in the user data partition.

In an alternative embodiment of the present invention, the second instruction is used to copy the software of the original version from a system partition to a user data partition; and use the software of the original version as the software of the reference version, differentially upgrade, by using the differential upgrade package, the software of the original version in the system partition to the software of the upgrade version, and enable the software of the upgrade version in the system partition.

The program memory 702 further stores a third instruction that is used to acquire a factory defaults restoration request, delete the software of the upgrade version according to the factory defaults restoration request, and enable the software of the original version. The processor 701 runs the third instruction.

The third instruction is used to format the user data partition according to the factory defaults restoration request, and enable the software of the original version in the system partition.

In an alternative embodiment of the present invention, the third instruction is used to perform, according to the factory defaults restoration request, an exchange between the software of the upgrade version in the system partition and the software of the original version in the user data partition; and format the user data partition, and enable the software of the original version in the system partition.

The first instruction may be used to control the transceiving antenna 703 to download, from a server to a cache partition, the differential upgrade package for the software of the original version.

It should be noted that, in the foregoing embodiments, only an Android® operating system is used as an example for description. However, a person skilled in the art should know that, an idea of the present invention may be applied to Symbian®, iOS®, or another operating system, so as to upgrade an operating system, which is not limited in the present invention.

In addition, the foregoing “enable” means modifying a configuration file or a registry parameter of an operating system (that is, software of an upgrade version) to enable the corresponding operating system to operate normally.

In addition, in the foregoing embodiments, a differential upgrade package for software of an original version is acquired by downloading, from a server to a cache partition, the differential upgrade package for the software of the original version. However, it should be noted that, a specific manner of acquiring the differential upgrade package for the software of the original version is not limited in the present invention. For example, in an alternative embodiment of the present invention, a differential upgrade package, which is stored in another mobile terminal, for software of an original version may be transmitted to a cache partition by using a Bluetooth® transmission function; or an externally inserted storage device is inserted into a mobile terminal, so that the mobile terminal may acquire a differential upgrade package, which is stored in the externally inserted storage device, for software of an original version.

Therefore, based on the foregoing disclosed content, in technical solutions disclosed in the present invention, software of an original version is used as software of a reference version, the software of the reference version is differentially upgraded, by using a differential upgrade package, to software of an upgrade version subsequently used by a mobile terminal, and the software of the original version is retained at the same time, which ensures that the software of the reference version is unchanged, thereby effectively resolving a problem that the software of the original version cannot be retained and a reference version subsequently upgraded is disorderly controlled.

In addition, in embodiments of the present invention, a factory defaults restoration request is acquired, software of an upgrade version is deleted according to the factory defaults restoration request, and software of an original version is enabled. The software of the original version is set upon delivery of a mobile terminal, after one or more differential upgrades, the mobile terminal can still re-enable the software of the original version when acquiring the factory defaults restoration request, so as to achieve a real function of factory defaults restoration.

In addition, in the several implementation manners provided in the present application, it should be understood that the disclosed system, apparatus, and method may be implemented in other manners. For example, the described implementation manners of the apparatus embodiment are merely exemplary. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the implementation manners of the embodiments of the present application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present application essentially, or the part contributing to the prior art, or all or some of the technical solutions may be implemented in the form of a software product. The software product is stored in a storage medium and includes several instructions for instructing a computer device (which may be a personal computer, a server, or a network device) or a processor to perform all or some of the steps of the methods described in the implementation manners of the embodiments of the present application. The foregoing storage medium includes any medium that can store program code, such as a universal serial bus (USB) flash disk, a removable hard disk, a read-only memory (ROM), a random access memory (RAM), a magnetic disk, or an optical disc.

The foregoing descriptions are merely embodiments of the present invention, and are not intended to limit the scope of the present invention. All equivalent structure or process changes made according to the content of this specification and accompanying drawings in the present invention or directly or indirectly applying the content of the specification and drawings of the present invention to other related technical fields shall fall within the protection scope of the present invention.

What is claimed is:

1. A software upgrade method for a mobile terminal comprising:
acquiring a differential upgrade package corresponding to a software of an original version;
using the software of the original version as a software of a reference version;
differentially upgrading, by using the differential upgrade package, the software of the reference version to a software of an upgrade version; and
retaining the software of the original version, wherein the retained software of the original version is used as a software of a reference version for performing a differential upgrade in a subsequent upgrade.

2. The method according to claim 1, wherein using the software of the original version as the software of the reference version, differentially upgrading, by using the differential upgrade package, the software of the reference version to the software of the upgrade version, and retaining the software of the original version comprises:
copying the software of the original version from a system partition to a user data partition;
using the software of the original version in the user data partition as the software of the reference version;
differentially upgrading, by using the differential upgrade package, the software of the reference version to the software of the upgrade version; and
enabling the software of the upgrade version in the user data partition.

3. The method according to claim 1, wherein using the software of the original version as the software of the reference version, differentially upgrading, by using the differential upgrade package, the software of the reference version to the software of the upgrade version, and retaining the software of the original version comprises:
copying the software of the original version from a system partition to a user data partition;
using the software of the original version in the system partition as the software of the reference version;
differentially upgrading, by using the differential upgrade package, the software of the reference version to the software of the upgrade version; and
enabling the software of the upgrade version in the system partition.

4. The method according to claim 1, further comprising:
acquiring a factory defaults restoration request;
deleting the software of the upgrade version according to the factory defaults restoration request; and
enabling the software of the original version.

5. The method according to claim 4, wherein deleting the software of the upgrade version according to the factory defaults restoration request, and enabling the software of the original version comprises:
formatting the user data partition according to the factory defaults restoration request; and
enabling the software of the original version in the system partition.

6. The method according to claim 4, wherein deleting the software of the upgrade version according to the factory defaults restoration request, and enabling the software of the original version comprises:
performing, according to the factory defaults restoration request, an exchange between the software of the upgrade version in the system partition and the software of the original version in the user data partition;
formatting the user data partition; and
enabling the software of the original version in the system partition.

7. The method according to claim 1, wherein acquiring the differential upgrade package corresponding to the software of the original version comprises downloading, from a server to a cache partition, the differential upgrade package corresponding to the software of the original version.

8. A mobile terminal comprising:
an antenna;
a memory; and
a processor coupled with the memory,
wherein the processor is configured to:
acquire a differential upgrade package corresponding to a software of an original version;
use the software of the original version as a software of a reference version;
differentially upgrade, by using the differential upgrade package, the software of the reference version to a software of an upgrade version; and
retain the software of the original version, wherein the retained software of the original version is used as a software of a reference version for performing a differential upgrade in a subsequent upgrade.

9. The mobile terminal according to claim 8, wherein the processor is configured to:
copy the software of the original version from a system partition to a user data partition;
use the software of the original version in the user data partition as the software of the reference version;
differentially upgrade, by using the differential upgrade package, the software of the reference version to the software of the upgrade version; and
enable the software of the upgrade version in the user data partition.

10. The mobile terminal according to claim 8, wherein the processor is configured to:
copy the software of the original version from a system partition to a user data partition;
use the software of the original version in the system partition as the software of the reference version;
differentially upgrade, by using the differential upgrade package, the software of the reference version to the software of the upgrade version; and
enable the software of the upgrade version in the system partition.

11. The mobile terminal according to claim 8, wherein the processor is configured to:
acquire a factory defaults restoration request;
delete the software of the upgrade version according to the factory defaults restoration request; and
enable the software of the original version.

12. The mobile terminal according to claim 11, wherein the processor is configured to:
format the user data partition according to the factory defaults restoration request; and
enable the software of the original version in the system partition.

13. The mobile terminal according to claim 11, wherein the processor is configured to:
perform, according to the factory defaults restoration request, an exchange between the software of the upgrade version in the system partition and the software of the original version in the user data partition;
format the user data partition; and
enable the software of the original version in the system partition.

14. The mobile terminal according to claim 8, wherein the processor is configured to download, from a server to a cache partition, the differential upgrade package corresponding to the software of the original version.
